(19) United States
(12) Patent Application Publication
(10) Pub. No.: US 2014/0045423 A1
(43) Pub. Date: Feb. 13, 2014

(54) ARRANGEMENT AND A METHOD FOR OPERATING AN ARRANGEMENT

(71) Applicants: Josef Haid, Graz (AT); Stefan Rueping, Lengdorf (DE); Walter Kargl, Graz (AT)

(72) Inventors: Josef Haid, Graz (AT); Stefan Rueping, Lengdorf (DE); Walter Kargl, Graz (AT)

(73) Assignee: INFINEON TECHNOLOGIES AG, Neubiberg (DE)

(21) Appl. No.: 13/568,168

(22) Filed: Aug. 7, 2012

(51) Int. Cl. H04B 5/00

(52) U.S. Cl. 455/41.1

(57) ABSTRACT

An arrangement including: an electronic device including a processor; a memory; a communication interface; and a power interface; an electronic circuit including: a communication interface to communicate with the electronic device via a communication interface of the electronic device; a near field communication interface to receive signals via an electromagnetic field; a processor to be powered by the electromagnetic field, to determine an operation program code to operate the electronic device from the signals received via the electromagnetic field, and to generate at least one operation program code message including the operation program code to be transmitted to the electronic device via the communication interfaces; a power interface to transmit electrical energy to the power interface of the electronic device to enable the electronic device to at least one of store and process the at least one operation program code message.

### TECHNICAL FIELD

Various embodiments relate generally to an arrangement and a method for operating an arrangement.

### BACKGROUND

Electronic devices often need to be configured and/or activated before being able to operate appropriately in a target environment. Typically the device may have to be unpacked and powered, e.g. by a power supply at its target destination. A configuration of an appliance that may be disconnected from a power supply, e.g. that may be packed and be on a truck for delivery, may not be possible. Dedicated and expensive efforts may have to be spent to enable configuration and/or activation of the appliances. Due to cost disadvantages, activation and configuration of electronic devices is normally used only if absolutely necessary.

### SUMMARY

Various embodiments provide an arrangement including: an electronic device including: a processor; a memory; a communication interface; a power interface coupled to at least one of the processor and the memory; an electronic circuit attached to the electronic device, the electronic circuit including: a communication interface configured to communicate with the electronic device via the communication interface of the electronic device; a near field communication interface configured to receive signals via an electromagnetic field; a processor configured to be powered by the electromagnetic field, to determine an operation signal configured to operate the electronic device from the signals received via the electromagnetic field, and to generate at least one operation program code message including the operation program code to be transmitted to the electronic device via the communication interfaces; a power interface configured to transmit electrical energy to the power interface of the electronic device to enable the electronic device to at least one of store and process the at least one operation program code message.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an arrangement according to an embodiment;

FIG. 2 shows an arrangement according to an embodiment;

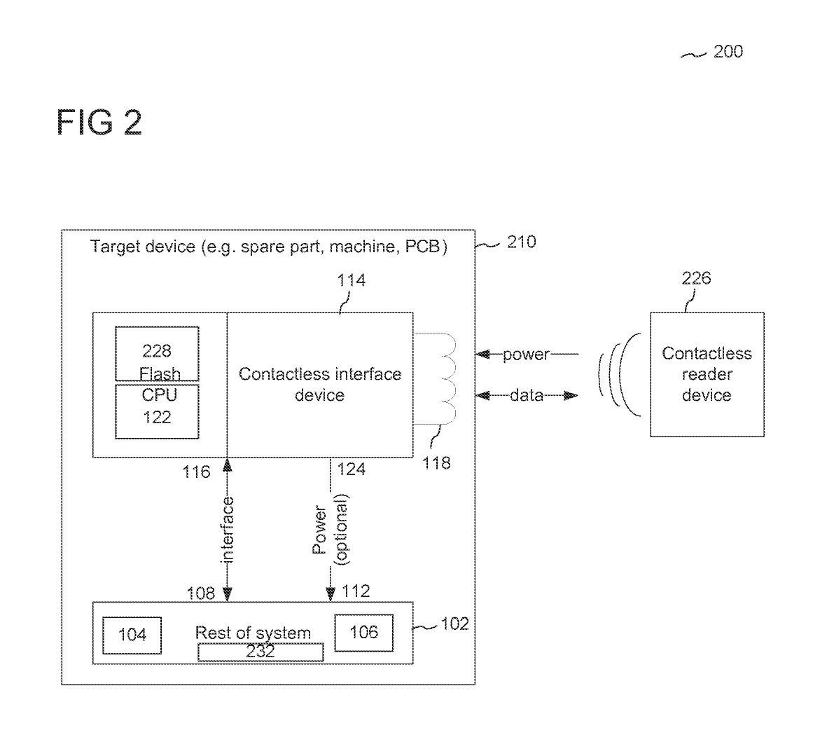

FIG. 3 shows a method for operating an arrangement according to an embodiment.

### DETAILED DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide an arrangement for simplifying processes and reducing costs associated with activation and/or configuration of electronic devices and new classes of devices.

Various embodiments provide an arrangement using the emerging infrastructure of mobile devices having the capability of communicating and powering devices through an RF field.

Various embodiments provide an arrangement using the emerging infrastructure of mobile devices, e.g. a contactless reader device, to power a device, e.g. a chip card and/or an RFID tag (Radio Frequency Identification tag), and a secondary device through the RF-field, wherein the power emitted by the contactless readers may be used to power the secondary device for the purpose of activation and configuration, and further for “standard” actions, like controlling a task on the secondary device via commands. The communication required to perform this task may be provided by the reader device as well as the target device.

Various embodiments provide an arrangement for activation and/or configuration of a target device, wherein no power supply or unpacking may be required by the target device to perform configuration and activation. For example, configuration, communication, data processing, and/or storage in the target device may be carried out without the need of a power supply attached to the electronic device. Power needed for operation may be provided by a contactless reader device emitting an RF-field. The communication between the reader and the extension of the electronic device may be performed by both devices.

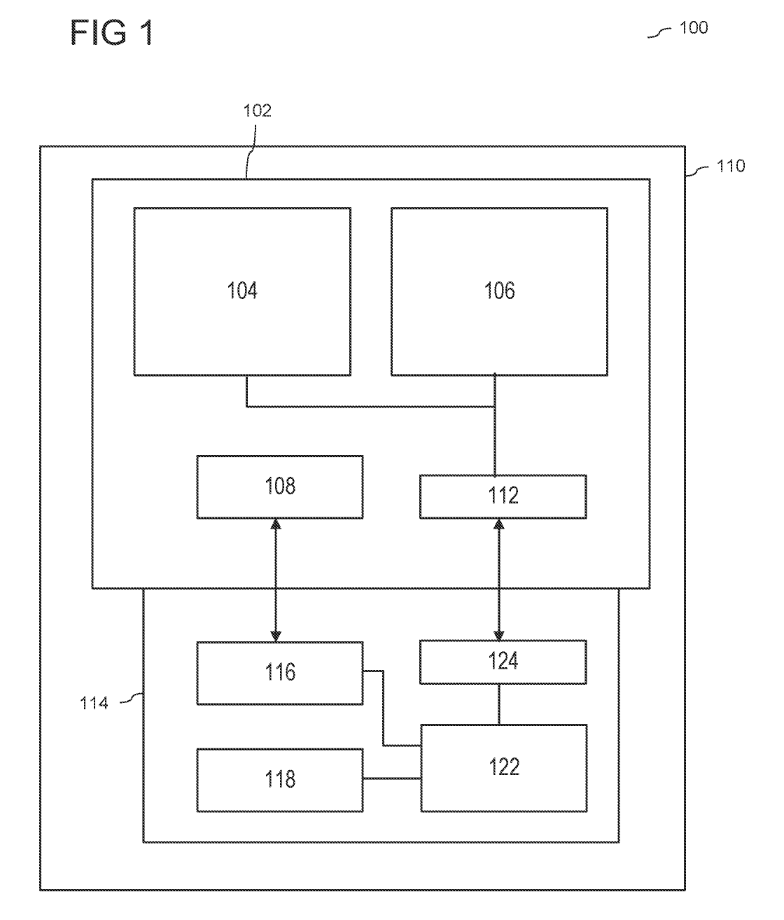

FIG. 1 shows arrangement 110 according to an embodiment. Arrangement 110 may include: an electronic device 102 including: a control logic 104; a memory element 106; a communication interface 108; a power interface 112 coupled to at least one of the control logic 104 and the memory element 106. Arrangement 110 may include an electronic circuit 114 attached to the electronic device 102, the electronic circuit 114 including: a communication interface 116 configured to communicate with the electronic device 102 via the communication interface 108 of the electronic device; a near field communication interface 118 configured to receive signals via an electromagnetic field; a processing circuit 122 configured to be powered by the electromagnetic field, to determine an operation signal configured to operate electronic device 102 from the signals received via the electromagnetic field, to process the operation signal and to transmit an operation message to the electronic device 102 via the communication interfaces 108, 116; a power interface 124 configured to transmit electrical energy to the power interface 112 of the electronic device to enable the electronic device 102 to at least one of store and process the operation message.

A near field communication interface 118 may include a communication interface configured for near field communication technology. Near field communication technology may refer to radio frequency technology operating at short-range distances, e.g. at distance of approximately a few cm, e.g. less than 3 cm, e.g. less than 5 cm, e.g. less than 20 cm. Near field communication interface 118 may be configured to receive signals via an electromagnetic field, e.g. via air. Near field communication interface 118 may include at least one antenna which may be configured to receive signals via an electromagnetic field via magnetic induction of the at least one loop antenna in near field communication interface 118 and at least one second loop antenna in a reader device, e.g. an initiating device. Near field communication devices may include a near field communication interface, which may be implemented in mobile communication devices, such as mobile phones, wherein the near field communication interface may be used for example in contactless systems, e.g. contactless payments, e.g. contactless data transfer, e.g. contactless credit systems. Standards for near field communication technology may include ISO/IEC 18000, ISO/IEC 18092, ISO/IEC 14443, ISO/IEC 15693, ISO/IEC 21481, NFC Forum specifications.

Arrangement 210 may include electronic device 102, wherein electronic device 102 may include control logic 104; memory element 106; communication interface 108; and power interface 112 coupled to at least one of the control logic 104 and the memory element 106. Arrangement 210 may further include electronic circuit 114 attached to the electronic device 102. Electronic circuit 114 may include: communication interface 116 configured to communicate with electronic device 102 via communication interface 108 of electronic device 102. Electronic device 102 may further include near field communication interface 118 configured to receive signals via an electromagnetic field. Electronic device 102 may further include processing circuit 122 configured to be powered by the electromagnetic field, to determine an operation signal configured to operate the electronic device 102 from the signals received via the electromagnetic field, and to generate at least one operation message including the operation signal to be transmitted to the electronic device 102 via the communication interfaces 108, 116. Electronic device 102 may further include power interface 124 configured to transmit electrical energy to the power interface 112 of the electronic device to enable the electronic device 102 to at least one of store and process the at least one operation message.

Arrangement 210 may include electronic device 102, wherein electronic device 102 may include the target device, e.g. a programmable device.

Electronic device 102 may include, for example, a household appliance, e.g. at least one of: a fridge, a washing machine, a drier. Electronic devices, such as electronic device 102 may need to be configured and/or activated before being able to operate appropriately in the target environment. Electronic device 102 may include one or more household appliances, e.g. kitchen devices, which may be activated and/or configured with personalized information, e.g. a specific language, e.g. a specific geographical location. This activation may take place at the target position or even before the electronic device 102 arrives at the target location. For example, configuration of device may be carried out prior to connecting it to a power supply line. Therefore, household devices may already be configured/personalized before the delivery to the customer without a need to plug it in to a power supply, e.g. configuration on the truck.

Electronic device 102 may include a mobile phone needed to be configured for a dedicated operator.

Electronic device 102 may include one or more spare parts for an electronic system, e.g. a car, e.g. electronic systems in automation industry, which may need to be “paired” with other target systems to work properly. Improved spare part management may result in configuration of spare parts prior to installation, e.g. a spare part of a car may be configured to a specific car prior to installation. As an example, a car lock may have to be configured to work with one specific car, and may therefore have to be configured for its specific target environment.

Electronic device 102 may include a programmable device, which may be activated to protect against burglary, e.g. at a payment counter after payment. Electronic consumer devices which may normally be powered by an external power supply device, may be protected against burglary, e.g. even before they are unpacked, e.g. without power supply, e.g. without battery power supply, as no battery and/or power supply may be attached before unpacking. The device may therefore be activated and/or configured by being powered by a contactless reader.

Electronic circuit 114 may include a chip card, e.g. a smart card according to ISO 7810. Electronic circuit 113 may include a contactless chip card. Electronic circuit 114, e.g. a chip card device, may include near field communication interface 118 configured to receive signals via an electromagnetic field in accordance with ISO/IEC 14443, ISO/IEC 18000, ISO/IEC 18092, ISO/IEC 14443, ISO/IEC 15693, ISO/IEC 21481, NFC Forum specifications.

Electronic circuit 114 may be attached to electronic device 102. As an example, electronic circuit 114 may be arranged in proximity to the electronic device 102, wherein communication between electronic circuit 114 and electronic device 102, via the communication interfaces 108, 116 may be possible. As an example, electronic circuit 114 may be glued and/or pasted to an outer shell of an electronic device 102. As another example, electronic circuit 114 may be integrated within electronic device 102, e.g. within an outer casing of electronic device 102. According to various embodiments, communication interfaces 108, 116 of the electronic device and the electronic circuit may each include a wireless communication interface, e.g. a near field communication interface. According to various embodiments, communication interfaces 108, 116 of the electronic device and the electronic circuit may each include one or more bus lines. For example, electronic device 102 and electronic circuit 114 may be hard-wired to each other via communication interfaces 108, 116. According to various embodiments, communication interfaces 108, 116 of the electronic device and the electronic circuit may each include at least one communication interface from the following group of communication interfaces, the group of communication interfaces consisting of: inter-integrated circuit interface (I2C), serial peripheral interface (SPI), university asynchronous synchronous interface (UART), Ethernet interface.

Near field communication interface 118 may be configured to receive signals via an electromagnetic field from contactless reader device 226, e.g. via inducting coupling of the electromagnetic field from contactless reader device 226. Contactless reader device 226 may be configured to transmit signals via an electromagnetic field, the electromagnetic field including power and data information, to electronic circuit 114 via near field communication interface 118. The signals, e.g. the transmitted signals from contactless reader device 226 may include radio frequency signals, e.g. at approximately 13.56 MHz or any other suitable frequency, e.g. any frequency used for contactless chip card communication. Near field communication interface 118 may be configured to receive signals via an electromagnetic field, wherein the electromagnetic field includes at least one data signal, e.g. from contactless reader device 226.

The at least one data signal may include at least one of the following data information: user information, language information, location information.

Processing circuit 122 may be configured to interpret the operation signal from the signals received via the electromagnetic field. The operation signal may include a binary coded signal, e.g. a data byte, envelope or packet. Processing circuit 122 may be configured to be powered by the electromagnetic field, to determine the operation signal configured to operate electronic device 102 from the signals received via the electromagnetic field, and to generate at least one operation message to be transmitted to the electronic device 102 via the communication interfaces 108, 116. The at least one operation message may include the operation signal, or may include an instruction for electronic device 102, e.g. a binary coded instruction for electronic device 102.

Processing circuit 122 may be configured to be powered by the electromagnetic field; and to determine the operation signal based on the at least one data signal. For example, power from the inductively coupled electromagnetic field may be provided to processing circuit 122 to receive and/or store the at least one data signal, and to determine an operation signal for electronic device 102. Electronic circuit 114, e.g. the chip card, may include one or more processors 122, e.g. a processing circuit 122 and optionally a coprocessor (not shown). Processing circuit 122 may include, e.g. a central processing unit, configured to control an operating system of the electronic circuit 114. Electronic circuit 114 may further include memory 228, e.g. a FLASH memory. Processing circuit 122 may be configured to receive and/or process the at least one data signal. The at least one data signal may be stored and/or written in memory 228, wherein processing circuit 122 may be configured to determine and/or generate an operation signal for electronic device 102. The operation signal may be necessary for the operation of electronic device 102. Processing circuit 122 may be configured to generate the at least one operation message including the operation signal based on the at least one data signal. Without the at least one data signal, the operation signal may not be generated and electronic device 102 may not be operable.

The at least one operation message may be transmitted from electronic circuit 114 to electronic device 102, via communication interfaces 108, 116. The at least one operation signal may be transmitted via a hard-wired communication interface or wirelessly, e.g. via communication interfaces 108, 116. Electronic device 102 may be configured to receive the at least one operation signal and store the at least one operation signal without any additional power supply, except from the at least one data signal and power provided by the electronic circuit 114. Electronic device 102 may therefore be understood to be powered by the electromagnetic field received by electronic circuit 114, which may be transmitted to electronic device 102 via power interface 124 of electronic circuit 114 to power interface 122 of electronic device 102.

Power interface 122 of electronic device 102 may be configured to optionally provide power from the electromagnetic field to at least one of control logic 104 of electronic device 102 and memory element 106 of the electronic device 102, to enable electronic device 102 to at least one of store and process the at least one operation message.

It may be understood, therefore, that various embodiments provide an arrangement for configuration and/or activation of devices, even, before the device may be connected to a further power supply, that is, without the further power supply needed for the operation of the electronic device. Whereas conventional configuration and/or activation of device may require dedicated configuration and/or activation devices, e.g. dedicated handhelds, various embodiments provide arrangements wherein such proprietary solutions from a supplier may no longer be necessary. For example, configuration of a washing machine may traditionally be carried out using infrared with dedicated handhelds, wherein these proprietary solutions may also expensive in terms of hardware, e.g. low volume, and software, e.g. availability of software developments tools may be low due to low volume of the hardware devices.

The at least one operation message may be necessary for the operation of electronic device 102, in other words, electronic device 102 may be unable to function and/or start up without the at least one operation message. In other words, the at least one operation message may be generated and/or stored in electronic device 102 even before electronic device 102 is powered up. Therefore, it may be understood, that the target device may no longer need to be unpacked and powered in order to generate and store the at least one operation message, which generates additional effort and can be critical in terms of damage. The at least one operation message may include a binary coded instruction, and/or a program code.

It may be understood, that electronic device 102 may include a further power interface 232 connected to a power supply, wherein the power supply may be configured to power electronic device 102 for operation, wherein the operation of electronic device 102 may be based on the at least one operation message. The power supply may be configured to power electronic device 102 for operation, after electronic device 102 has at least one of stored and processed the at least one operation message, wherein the operation of the electronic device is based on the at least one operation message.

In addition to providing power and data information, contactless reader device 226 may be configured to transmit further information via the electromagnetic field. Contactless reader device 226 may include, e.g. a mobile communication device, e.g. a mobile device having the capability of communicating and powering devices through an RF field, e.g. a mobile phone enabled with NFC interface, e.g. contactless payment terminals. Contactless reader device 226, e.g. a mobile communication device, may be configured to transmit information associated with services on mobile devices, e.g. GPS information to electronic circuit 114 and eventually electronic device 102. For example, electronic device 102 may be only allowed to be activated in a certain region of the world. Electronic device 102 may be configured prior to shipment with GPS information. At activation, the GPS information of the contactless reader device 226, e.g. the mobile phone, may be cross-checked with the information stored in electronic device 102, i.e. the RF-powered target device. Furthermore, an online connect to a background system can be used to store information about the configuration.

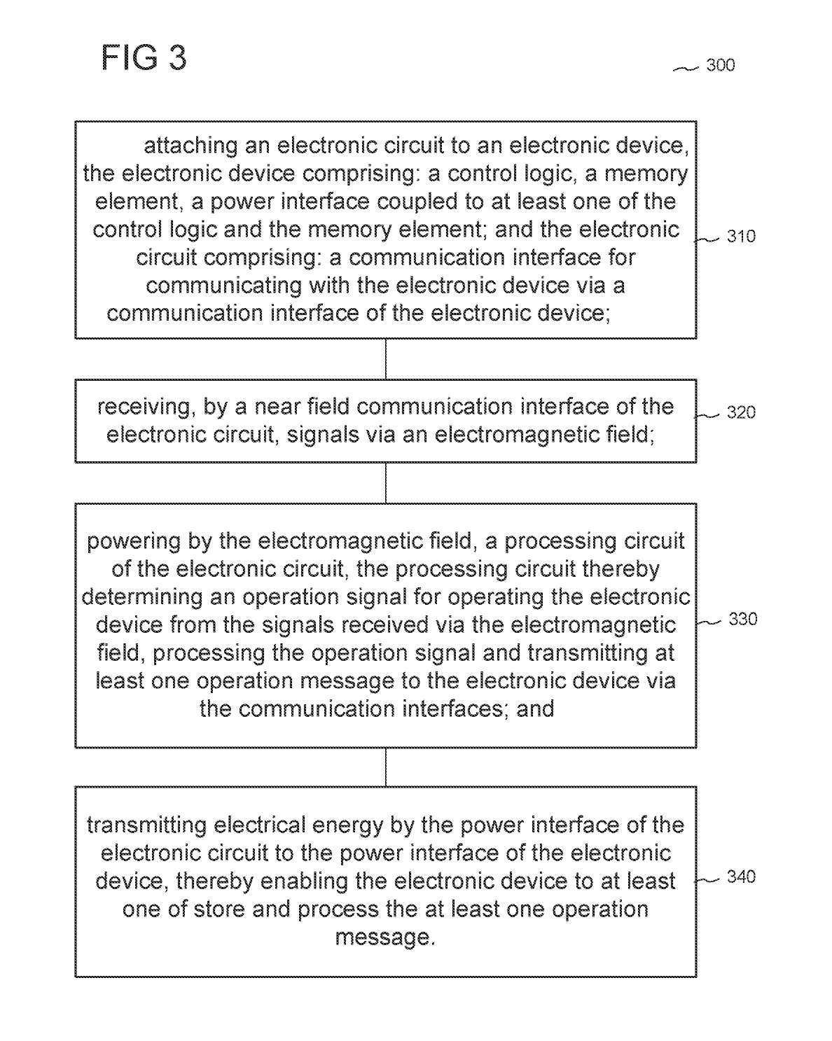

FIG. 3 shows method 300 for operating an arrangement. Method 300 may include:
attaching an electronic circuit to an electronic device, the electronic device including a processor, a memory, a power interface coupled to at least one of the processor and the memory; and the electronic circuit including a communication interface for communicating with the electronic device via a communication interface of the electronic device (in 310);
receiving, by a near field communication interface of the electronic circuit, signals via an electromagnetic field (in 320);
powering by the electromagnetic field, a processor of the electronic circuit, the processor thereby determining an operation signal for operating the electronic device from the signals received via the electromagnetic field, and processing the operation signal and transmitting at least one operation message to the electronic device via the communication interfaces (in 330); and
transmitting electrical energy by the power interface of the electronic circuit to the power interface of the electronic device, thereby enabling the electronic device to at least one of store and process the at least one operation message (in 340).

Various embodiments provide an arrangement including: an electronic device including: control logic; a memory element; a communication interface; a power interface coupled to at least one of the control logic and the memory element; an electronic circuit attached to the electronic device, the electronic circuit including: a communication interface configured to communicate with the electronic device via the communication interface of the electronic device; a near field communication interface configured to receive signals via an electromagnetic field; a processing circuit configured to be powered by the electromagnetic field, to determine an operation signal configured to operate the electronic device from the signals received via the electromagnetic field, to process the operation signal and to transmit an operation message to the electronic device via the communication interfaces; a power interface configured to transmit electrical energy to the power interface of the electronic device to enable the electronic device to at least one of store and process the operation message.

According to an embodiment, the electronic device includes a programmable device.

According to an embodiment, the electronic device includes a household appliance.

According to an embodiment, the electronic device includes at least one of: a fridge, a washing machine, a drier.

According to an embodiment, the electronic circuit includes a chip card.

According to an embodiment, the electronic circuit includes a contactless chip card.

According to an embodiment, the near field communication interface is configured to receive signals via an electromagnetic field, wherein the electromagnetic field includes at least one data signal.

According to an embodiment, the processing circuit is configured to be powered by the electromagnetic field; and to determine the operation signal based on the at least one data signal.

According to an embodiment, the processing circuit is configured to generate the at least one operation message including the operation signal based on the at least one data signal.

According to an embodiment, the power interface of the electronic device is configured to provide power from the electromagnetic field to at least one of the control logic of the electronic device and the memory element of the electronic device, to enable the electronic device to at least one of store and process the at least one operation message.

According to an embodiment, the electronic device includes a further power interface connected to a power supply, wherein the power supply is configured to power the electronic device for operation, wherein the operation of the electronic device is based on the at least one operation message.

According to an embodiment, the electronic device includes a further power interface connected to a power supply, wherein the power supply is configured to power the electronic device for operation, after the electronic device has at least one of stored and processed the at least one operation message, wherein the operation of the electronic device is based on the at least one operation message.

According to an embodiment, the electromagnetic field includes at least data signal, the at least one data signal including at least one of the following data information: user information, language information, location information.

According to an embodiment, the communication interfaces of the electronic device and the electronic circuit each include a wireless communication interface.

According to an embodiment, the communication interfaces of the electronic device and the electronic circuit each include one or more bus lines.

According to various embodiments, the communication interfaces of the electronic device and the electronic circuit each include at least one communication interface from the following group of communication interfaces, the group of communication interfaces consisting of: inter-integrated circuit interface (I2C), serial peripheral interface (SPI), university asynchronous synchronous interface (UART), Ethernet interface.

Various embodiments provide an arrangement including: an electronic device including: control logic; a memory element; a communication interface; a power interface coupled to at least one of the control logic and the memory element; an electronic circuit attached to the electronic device, the electronic circuit including: a communication interface configured to communicate with the electronic device via the communication interface of the electronic device; a near field communication interface configured to receive signals via an electromagnetic field; a processing circuit configured to be powered by the electromagnetic field, to determine an operation signal configured to operate the electronic device from the signals received via the electromagnetic field, and to generate at least one operation message including the operation signal to be transmitted to the electronic device via the communication interfaces; a power interface configured to transmit electrical energy to the power interface of the electronic device to enable the electronic device to at least one of store and process the at least one operation message.

According to an embodiment, the electronic device includes a programmable device.

According to an embodiment, the electronic device includes a household appliance.

According to an embodiment, the electronic circuit includes a contactless chip card.

According to an embodiment, the near field communication interface is configured to receive signals via an electromagnetic field, wherein the electromagnetic field includes at least one data signal.

According to an embodiment, the processing circuit is configured to be powered by the electromagnetic field; and to determine the operation signal based on the at least one data signal.

According to an embodiment, the electronic device includes a further power interface connected to a power supply, wherein the power supply is configured to power the electronic device for operation, wherein the operation of the electronic device is based on the at least one operation message.

Various embodiments provide a method for operating an arrangement, the method including attaching an electronic circuit to an electronic device, the electronic device including: control logic, a memory element, a power interface coupled to at least one of the control logic and the memory element; and the electronic circuit including: a communication interface for communicating with the electronic device via a communication interface of the electronic device; receiving, by a near field communication interface of the electronic circuit, signals via an electromagnetic field; powering by the electromagnetic field, a processing circuit of the electronic circuit, the processing circuit thereby determining an operation signal for operating the electronic device from the signals received via the electromagnetic field, processing the operation signal and transmitting at least one operation message to the electronic device via the communication interfaces; and transmitting electrical energy by the power interface of the electronic circuit to the power interface of the electronic device, thereby enabling the electronic device to at least one of store and process the at least one operation message.

Various embodiments provide a method for operating an arrangement, the method including attaching an electronic circuit to an electronic device, the electronic device including: a control logic, a memory element, a power interface coupled to at least one of the control logic and the memory element; and the electronic circuit including: a communication interface for communicating with the electronic device via a communication interface of the electronic device; receiving, by a near field communication interface of the electronic circuit, signals via an electromagnetic field; powering by the electromagnetic field, a processing circuit of the electronic circuit, the processing circuit thereby determining an operation signal for operating the electronic device from the signals received via the electromagnetic field, and thereby generating at least one operation message including the operation signal to be transmitted to the electronic device via the communication interfaces; and transmitting electrical energy by the power interface of the electronic circuit to the power interface of the electronic device, thereby enabling the electronic device to at least one of store and process the at least one operation message.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An arrangement including:
an electronic device comprising:
control logic;
a memory element;
a communication interface;
a power interface coupled to at least one of the control logic and the memory element;
an electronic circuit attached to the electronic device, the electronic circuit comprising:
a communication interface configured to communicate with the electronic device via the communication interface of the electronic device;
a near field communication interface configured to receive signals via an electromagnetic field;
a processing circuit configured to be powered by the electromagnetic field, to determine an operation signal configured to operate the electronic device from the signals received via the electromagnetic field, to process the operation signal and to transmit an operation message to the electronic device via the communication interfaces;
a power interface configured to transmit electrical energy to the power interface of the electronic device to enable the electronic device to at least one of store and process the operation message.

2. The arrangement according to claim 1,
wherein the electronic device comprises a programmable device.

3. The arrangement according to claim 1,
wherein the electronic device comprises a household appliance.

4. The arrangement according to claim 1,
wherein the electronic device comprises at least one of: a fridge, a washing machine, a drier.

5. The arrangement according to claim 1,
wherein the electronic circuit comprises a chip card.

6. The arrangement according to claim 5,
wherein the electronic circuit comprises a contactless chip card.

7. The arrangement according to claim 1,
wherein the near field communication interface is configured to receive signals via an electromagnetic field, wherein the electromagnetic field comprises at least one data signal.

8. The arrangement according to claim 7,
wherein the processing circuit is configured to be powered by the electromagnetic field; and
to determine the operation signal based on the at least one data signal.

9. The arrangement according to claim 8,
wherein the processing circuit is configured to generate the at least one operation message based on the at least one data signal.

10. The arrangement according to claim 8,
wherein the power interface of the electronic device is configured to provide power from the electromagnetic field to at least one of the control logic of the electronic device and the memory element of the electronic device, to enable the electronic device to at least one of store and process the at least one operation message.

11. The arrangement according to claim 1,
wherein the electronic device comprises a further power interface connected to a power supply, wherein the power supply is configured to power the electronic device for operation, wherein the operation of the electronic device is based on the at least one operation message.

12. The arrangement according to claim 1,
wherein the electronic device comprises a further power interface connected to a power supply, wherein the power supply is configured to power the electronic device for operation, after the electronic device has at least one of stored and processed the at least one operation message, wherein the operation of the electronic device is based on the at least one operation message.

13. The arrangement according to claim 1,
wherein the electromagnetic field comprises at least data signal, the at least one data signal comprising at least one of the following data information: user information, language information, location information.

14. The arrangement according to claim 1,
wherein the communication interfaces of the electronic device and the electronic circuit each comprise a wireless communication interface.

15. The arrangement according to claim 1,
wherein the communication interfaces of the electronic device and the electronic circuit each comprise one or more bus lines.

16. The arrangement according to claim 1,
wherein the communication interfaces of the electronic device and the electronic circuit each comprise at least one communication interface from the following group of communication interfaces, the group of communication interfaces consisting of: inter-integrated circuit interface, serial peripheral interface, university asynchronous synchronous interface, Ethernet interface.

17. An arrangement comprising:
an electronic device comprising:
control logic;
a memory element;
a communication interface;
a power interface coupled to at least one of the control logic and the memory element;
an electronic circuit attached to the electronic device, the electronic circuit comprising:
a communication interface configured to communicate with the electronic device via the communication interface of the electronic device;
a near field communication interface configured to receive signals via an electromagnetic field;
a processing circuit configured to be powered by the electromagnetic field, to determine an operation signal configured to operate the electronic device from the signals received via the electromagnetic field, and to generate at least one operation message comprising the operation signal to be transmitted to the electronic device via the communication interfaces;
a power interface configured to transmit electrical energy to the power interface of the electronic device to enable the electronic device to at least one of store and process the at least one operation message.

18. The arrangement according to claim 17,
wherein the electronic device comprises a programmable device.

19. The arrangement according to claim 17,
wherein the electronic device comprises a household appliance.

20. The arrangement according to claim 17,
wherein the electronic circuit comprises a contactless chip card.

21. The arrangement according to claim 17,
wherein the near field communication interface is configured to receive signals via an electromagnetic field, wherein the electromagnetic field comprises at least one data signal.

22. The arrangement according to claim 21
wherein the processing circuit is configured to be powered by the electromagnetic field; and
to determine the operation signal based on the at least one data signal.

23. The arrangement according to claim 17,
wherein the electronic device comprises a further power interface connected to a power supply, wherein the power supply is configured to power the electronic device for operation, wherein the operation of the electronic device is based on the at least one operation message.

24. A method for operating an arrangement, the method comprising
attaching an electronic circuit to an electronic device,
the electronic device comprising:
a control logic, a memory element, a power interface coupled to at least one of the control logic and the memory element;
and the electronic circuit comprising:
a communication interface for communicating with the electronic device via a communication interface of the electronic device;
receiving, by a near field communication interface of the electronic circuit, signals via an electromagnetic field;
powering by the electromagnetic field, a processing circuit of the electronic circuit, the processing circuit thereby determining an operation signal for operating the electronic device from the signals received via the electromagnetic field, processing the operation signal and transmitting at least one operation message to the electronic device via the communication interfaces; and
transmitting electrical energy by the power interface of the electronic circuit to the power interface of the electronic device, thereby enabling the electronic device to at least one of store and process the at least one operation message.

25. A method for operating an arrangement, the method comprising
attaching an electronic circuit to an electronic device,
the electronic device comprising:
a control logic, a memory element, a power interface coupled to at least one of the control logic and the memory element;
and the electronic circuit comprising:
a communication interface for communicating with the electronic device via a communication interface of the electronic device;
receiving, by a near field communication interface of the electronic circuit, signals via an electromagnetic field;
powering by the electromagnetic field, a processing circuit of the electronic circuit, the processing circuit thereby determining an operation signal for operating the electronic device from the signals received via the electromagnetic field, and thereby generating at least one operation message comprising the operation signal to be transmitted to the electronic device via the communication interfaces; and
transmitting electrical energy by the power interface of the electronic circuit to the power interface of the electronic device, thereby enabling the electronic device to at least one of store and process the at least one operation message.
